(19) United States
(12) Patent Application Publication
(10) Pub. No.: US 2013/0118981 A1
(43) Pub. Date: May 16, 2013

(54) POROUS HOLLOW FIBER

(71) Applicants: Roland Vogel, Dresden (DE); Claudia Hinueber, Dresden (DE); Marijan Vucak, Altendiez (DE); Christoph Nover, Rheinberg (DE)

(72) Inventors: Roland Vogel, Dresden (DE); Claudia Hinueber, Dresden (DE); Marijan Vucak, Altendiez (DE); Christoph Nover, Rheinberg (DE)

(73) Assignee: SCHAEFER KALK GMBH & CO. KG, Diez (DE)

(21) Appl. No.: 13/811,661

(22) PCT Filed: Jul. 28, 2011
(86) PCT No.: PCT/EP11/03775

§ 371 Date: Jan. 22, 2013

(30) Foreign Application Priority Data
Jul. 30, 2010 (EP) 10007958.1
Aug. 6, 2010 (EP) 10008206.4

(51) Int. Cl. D01D 5/247; B01D 69/08

(52) U.S. Cl. CPC D01D 5/247; B01D 69/08
USPC 210/650; 428/398; 428/372; 264/209.2; 264/291; 264/138

(57) ABSTRACT

Porous hollow fibers comprising first pores having an average length in the range from 0.045 μm to 120 μm and an average width in the range from 0.030 μm to 20 μm, measured in a fiber direction, wherein the ratio of the average length of the first pores to the average width of the first pores is at least 1.5:1, second pores having an average length in the range from 0.1 nm to 99 nm and an average width in the range from 1 nm to 20000 nm, measured in the direction of the fiber in each case, wherein the ratio of the average length of the second pores to the average width of the second pores is not more than 1:1.5. Preferred application areas include use in fillings, in selectively permeable membranes, for the immobilization of enzymes and/or cells, for hemodialysis, and for storage of hydrogen.

The present invention relates to porous hollow fibers that comprise at least one preferably semi-crystalline polymer, and a method for producing and using such fibers.

Hollow fibers are known and the term is used to designate filament yarns or fibers spun from viscose or synthetic fibers with air inclusions, which are created by special spinning nozzles, for example in polyester fibers or by CO₂ development during the spinning process for example by adding extra sodium bicarbonate to the viscose spinning solution. Compared with usual fibers, hollow fibers are normally more full-bodied and have greater thermal insulation capability. For industrial applications, hollow fibers are also manufactured from cellulose acetate, polysulphone, polyacryl nitrile, polymethylmethacrylate, polyamide, polybenzimidazol or glass.

Preferred fields of application for hollow fibers include fillings for bedspreads, pillows, sleeping bags, protective clothing for cold weather; their use in capillary membrane filters for ultrafiltration and reverse osmosis for desalinating, concentrating, fractionating proteins, enzymes and similar and their use for air separation, for immobilizing enzymes and cells and for haemodialysis.

Various methods are known for producing porous hollow fibers. The conventional way is the stretching process. Thus for example many crystalline polymers can be converted to a highly orientated morphological state by stretching. The resulting fibers are particularly notable for their greater modulus, improved strength, significantly increased stretchability and a highly elastic recovery capability from substantial elongations.

This behavior is explained particularly by the lamellar structural segments of the polymers perpendicularly to the direction of the fibers. When the polymers are stretched, micropores are formed because the lamellae are pulled away from each other, and the precise shape of the pores and the resulting distribution of the pores are affected by many different parameters, such as the stretching ratio, the spinning temperature and the tempering temperature.

Thus, while such a process is easy to carry out, the many different influencing factors that must be considered mean that the exact shape of the pores and their distribution along the fiber are difficult to control and determine.

Another method for producing porous hollow fibers is thermally induced phase separation (TIPS). In this, a homogeneous solution is usually prepared at an elevated temperature by dissolving the polymer in a solvent that has a high boiling point and a low molecular weight. The solution is spun to form hollow fibers and is then cooled at a controlled rate or quenched to bring about a phase separation. After the solvent has been removed, usually by solvent extraction, microporous hollow fibers are obtained.

The structure of the hollow fibers depends to a large extent on the thermodynamic interactions between the polymer and the solvent, the composition of the co-existing phases, the temperature, the cooling conditions and other factors that affect the kinetics of phase growth as soon as a phase separation has taken place.

However, the fibers that can be obtained with the TIPS method are relatively brittle, and they are stuck to each other. They usually exhibit lower permeability than porous hollow fibers that are obtained by stretching.

Finally, it has also been suggested to produce hollow fibers according to a spinning process in which a further polymer or microparticles that are insoluble in the spinning compound are added to the polymer that is to be spun. After the spinning process, the additional polymer or microparticles should then be dissolved out using a selective solvent.

The production and properties of porous hollow fibers are also described in the patent literature and other publications. In this context, polypropylene is most frequently used as the starter material.

For example, U.S. Pat. No. 5,232,642 relates to a process for producing porous hollow fiber membranes from polypropylene. These hollow fibers have large, rectangular pores with pore diameters from 1 μm to 10 μm. They are produced by melt spinning with a hollow fiber nozzle. The pores are created by stretching the material multiple times at various temperatures, interspersed with tempering processes, also at various temperatures.

U.S. Pat. No. 6,890,436 describes hollow fiber membranes with holes of a size between 1 μm and 10 μm. These hollow fiber membranes are produced in a wet spinning process. Microparticles that are insoluble in the solvent of the spinning solution are added to the spinning solution of polymer, solvent and an additive for phase separation in the spinning bath. After the spinning process, the microparticles are dissolved out using a selective solvent.

Examples of such microparticles include metal oxides such as silicon oxide, zinc oxide and aluminum oxide, metal microparticles such as silicon, zinc, copper, iron and aluminum, and inorganic compounds such as sodium chloride, sodium acetate, sodium phosphate, calcium carbonate and calcium hydroxide, particularly microparticles of silicon oxides. The average particle size of the microparticles should preferably be in the range from 1 μm to 20 μm, and more preferably in the range from 2 μm to 10 μm.

Patent application EP 0 168 783 A1 discloses asymmetrical microporous hollow fibers for haemodialysis and methods for production thereof. The hollow fiber consists of 90% by weight to 99% by weight hydrophobic polymer and 10% by weight to 1% by weight hydrophilic polymer and has a water absorbing capacity of 3% by weight to 10% by weight, wherein the hollow fiber is produced by precipitating an extruded solution of 12% by weight to 20% by weight first polymer, 2% by weight to 10% by weight second polymer, with the remainder being solvent, from the inside out while simultaneously dissolving a portion of the pore-forming agent out of the extrudate, then washing out the dissolved out portion of the pore-forming agent and the other organic components, and fixing the fibers thus obtained in a wash bath.

U.S. Pat. No. 5,435,955 describes a process for manufacturing porous hollow fibers and films from polypropylene, in which a large number of micropores are created in the hollow fibers or films in a stretching process that takes place in a temperature range from 110° C. to 155° C. The stretching rate is less than 10%/min.

In the publication by S. Nago, Y. Mizutani Microporous Polypropylene Hollow Fibers Containing Calcium Carbonate Fillers J. Electron Microsc. 42 (1993) 407-411, melt-spun microporous hollow fibers made from polypropylene and containing 60% by weight calcium carbonate are described. The micropores are created in a stretching process of the hollow fibers. The calcium carbonate is removed by a mixture of hydrochloric acid and methanol. The pore size achieved thereby is dependent on the particle size of the calcium carbonate. The calculated pore sizes are between 200 nm and 2 μm.

In an article by K. Abrol, G. N. Qazi, A. K. Ghosh Characterization of an anion-exchange porous polypropylene hollow fiber membrane for immobilization of ABL lipase Journal of Biotechnology 128 (2007) 838-848, a commercial polypropylene hollow fiber having an internal diameter of 240 μm, an external diameter of 300 μm, an average pore diameter of 100 μm and porosity of 40% is modified by radiation-induced graft polymerization. Glycidyl methacrylate is grafted using gamma radiation. This graft causes the round pore diameter to shrink to a minimum of 0.6 μm.

In the document by L. Mei, D. Zhang, Q. Wang Morphology Structure Study of Polypropylene Hollow Fiber Membrane Made by the Blend-Spinning and Cold-Stretching Method, Journal of Applied Polymer Science 84 (2002) 1390-1394, a blend of polypropylene and a mildly hydrolytically degradable polyester is described. After melt spinning with a hollow fiber nozzle, the hollow fiber is stretched at 45° C. The polyester is removed. This results in elongated pores having an average length of 30 μm and an average width of 5 μm.

The publication by M. Sakai, S. Matsunami The Structure and Characteristics of Polypropylene Hollow Fiber Membrane Plasma Separator, Therapeutic Apheresis and Dialysis 7 (2003) 1, 69-72 describes a commercial hollow fiber membrane made from polypropylene. This membrane has ordered rectangular pores with an average pore width of 0.2 μm. The maximum pore width is 0.6 μm.

In the document by S. Nago, Y. Mizutani Microporous Polypropylene Hollow Fibers with Double Layers, Journal of Applied Polymer Science 56 (1995) 253-261, a microporous hollow fiber with a double layer of polypropylenes is described. These porous hollow fibers are produced in a stretching process of double-layer hollow fibers that contain polymethylsilsesquioxane (PMSO) filler materials. In this case, the filler material particles in the inner layer are relatively small, but in the outer layer the filler material particles are quite large. In the outer layer, the pores created are elongated, having an average length of 10 μm and an average width of 2 μm. The inner layer comprises elongated pores with an average length of 5 μm and an average width of 1 μm.

In the article by B. Gu, Q. Du, Y. Yang Microporous hollow fiber membranes formed from blends of isotactic and atactic polypropylene, Journal of Membrane Science 164 (2000) 59-65, microporous hollow fibers are described that are spun from blends of isotactic and atactic polypropylene. The atactic polypropylene is removed after melt spinning by extraction. Then the hollow fiber is cold stretched. The membranes have smaller pore diameters and higher permeabilities than hollow fibers that are produced by traditional stretching processes. The average pore diameter is 0.017 μm.

The article by S. Nago, Y. Mizutani Microporous Polypropylene Fibers Containing CaCO₃ Filler, Journal of Applied Polymer Science 62 (1996) 81-86, describes a similar method to the publication by S. Nago, Y. Mizutani Microporous Polypropylene Hollow Fibers Containing Calcium Carbonate Fillers J. Electron Microsc. 42 (1993) 407-411. The only difference between the two consists in that in the second case only porous fibers are produced. Elongated pores with an average pore length of 15 μm and an average pore width of 4 μm are created.

In the publication by T. Schimanski, J. Loos, T. Peijs, B. Alcock, P. J. Lemstra On the Overdrawing of Melt-Spun Isotactic Polypropylene Tapes, Journal of Applied Polymer Science 103 (2007) 2920-2931, the production of melt-spun foil tapes made from polypropylene is described. After melt-spinning, the foil tapes undergo subsequent stretching with a stretching ratio A greater than 10 (overdrawing) in a hot air oven. Under these extreme stretching conditions, the morphology of the foil tapes changes. Their color changes from transparent to opaque. After etching with permanganate, elongated pores with an average length of 1 μm and a width of 0.2 μm are visible.

The article by J.-J. Kim, T.-S. Jang, Y.-D. Kwon, U. Y. Kim, S. S. Kim Structural study of microporous polypropylene hollow fiber membranes made by the melt-spinning and cold-stretching method, Journal of Membrane Science 93 (1994) 209-215 describes the production of microporous hollow fibers in a melt spinning process with subsequent cold stretching. The spun hollow fibers are tempered for 30 min at 60° C. to 140° C. in a cycle that is repeated three times and then stretched at room temperature to produce the micropores. The stretching ratios are 30%, 30% and 50%. The average diameters of the round pores are 100 μm.

In the publication by C.-A. Lin, H.-C. Tsai, T.-C. An, C.-C. Tung Hollow Porous Polypropylene Fibers with Polyvinyl Alcohol by Melt Spinning, http://dspace.lib.fcu.edu.tw/bitstream/2377/3879/1/ce05atc902007000008.pdf Aug. 15, 2007, the production of microporous hollow fibers from polypropylene by spinning a blend of polypropylene and water-soluble polyvinyl alcohol (ratio 80:20) is described. The polyvinyl alcohol is removed by water treatment for 60 min at 70° C. This yields pores having an average length of 5 μm and a width of 1 μm.

Finally, precipitated calcium carbonate particles with rhombohedral morphology that are designed for use as filler agents in polymers, dyes and coatings among other purposes are known from patent application WO 2007/068593. However, textile fibers, particularly hollow fibers, are not mentioned in this document.

Given this state of the art, it was the object of the present invention to suggest improved ways for producing porous hollow fibers that can be implemented on an industrial scale as simply, inexpensively and efficiently as possible. At the same time, the properties profile of the resulting hollow fibers should be further improved if possible. In particular, it was attempted to achieve a pore shape that was as well defined and controllable as possible, and the most uniform pore distribution possible.

The object of the invention consisted particularly in providing access to porous hollow fibers that have continuous porosity, preferably microporosity, for perfusion with gases or liquids, and pores, preferably nanopores, and also pore geometries that render them suitable for adsorbing gases or liquid substances.

Finally, it was also intended to point out application areas in which the hollow fibers according to the invention might be particularly well used.

These and other objects that arise directly from the associations under discussion are solved with a porous hollow fiber having all of the features of claim 1. Protection is also claimed for a particularly advantageous process for preparing the porous hollow fibers, particularly suitable intermediate products and particularly practical application areas.

By producing a porous hollow fiber containing first pores with
an average length in the range from 0.045 μm to 120 μm and
an average width in the range from 0.030 μm to 20 μm, each measured in the direction of the fiber,
wherein the ratio of the average length of the first pores to the average width of the first pores is at least 1.5:1,
wherein the hollow fiber further contains second pores with
an average length in the range from 0.1 nm to 99 nm and
an average width in the range from 1 nm to 20000 nm, each measured in the direction of the fiber,
   wherein the ratio of the average length of the second pores to the average width of the second pores is not more than 1:1.5, it is possible, in a manner not immediately predictable, to provide a porous hollow fiber with an improved properties profile, which is notable particularly for the better definition of its pores and the more even distribution of the pores. The porous hollow fiber according to the in invention exhibits continuous porosity, particularly microporosity, enabling perfusion with gases or liquids. Additionally, it includes pores, particularly nanopores having pore geometries that are suitable for adsorption of gases or liquid substances.

Furthermore, the solution according to the invention may be implemented on a large scale relatively simply and extremely inexpensively and efficiently.

Finally, due to its outstanding properties profile the porous hollow fiber is able to be used particularly advantageously in many application areas.

According to a first aspect, the present invention relates to a first hollow fiber that is particularly suitable for producing the porous hollow fiber according to the invention.

In this context, the term “fiber” designates the thin strand that is primarily created and has a large ratio of length to cross section. On the other hand, the term “thread” is understood to mean a set of single fibers. For further information about these technical terms of the textile industry, the reader is referred particularly to Hans-Georg Elias Makromoleküle Weinheim, Wiley-VCH, 6th edition, 2003, volume 4 Anwendungen von Polymeren, chapter 6 Fasern, Faclen und Gewebe, pages 154 to 243, and Franz Fourné Synthetische Fasern—Herstellung, Maschinen und Apparate, Eigenschaften; Handbuch für Anlagenplanung, Maschinenkonstruktion and Betrieb, Munich, Vienna; Hanser 1995 and the sources cited therein.

Within the terms of the present invention, the first hollow fiber comprises at least one polymer, preferably at least one polymer that is able to undergo thermoplastic processing, and which is preferably also semicrystalline. Polymers that are particularly well suited to the purposes of the present invention include cellulose polymers, particularly cellulose acetates, polyacrylates, poly(aryl-ether-ether-ketones), polymethacrylates, particularly polymethylmethacrylates, polyacrylonitriles, polyimides, particularly polybenzimidazoles, polyamides, polyesters, polysulphones, polyolefins, particularly polypropylenes, polylactic acid, polybutyric acid and mixtures thereof.

Within the terms of a most particularly preferred embodiment of the present invention, the first hollow fiber contains at least one polyolefin, in particular at least one polypropylene, expediently at least one isotactic polypropylene or at least one syndiotactic polypropylene.

The polymer that is used according to the invention, preferably the thermoplastically processable polymer, particularly the polypropylene, preferably has a melt index (MI) of 0.5 to 30 measured according to the procedure described in ASTM D-1238. The melt index is particularly preferably within the range from 1 to 15.

Within the terms of the present invention, the first hollow fiber also contains calcium carbonate particles, preferably precipitated calcium carbonate (PPC) particles with specific properties.

In this context, the term “particle” includes crystallites or primary particles as well as clusters of primary particles. Crystallites or primary particles are defined as the smallest elementary entities that can be distinguished with electron microscope imaging.

Within the terms of the present invention, the term “calcium carbonate particle” designates particles that contain at least 95.0% by weight, preferably at least 99.0% by weight, particularly at least 99.5% by weight CaCO₃ relative to their total weight.

The calcium carbonate particles of the present invention are preferably substantially crystalline. It is beneficial if at least 50% by weight, preferably at least 75% by weight, particularly at least 90% by weight of the calcium carbonate particles are present in the crystalline form. The calcium carbonate particles particularly preferably contain fractions of calcite and/or aragonite, wherein the calcite fraction is advantageously greater than 30% by weight, preferably greater than 50% by weight, particularly greater than 90% by weight. According to the invention, the degree of crystallinity of the calcium carbonate particles and the nature of the crystalline phases are preferably determined by X-ray diffraction.

Within the terms of the present invention, the crystallites of the calcium carbonate particles have an aspect ratio lower than 5, preferably lower than 4, more preferably lower than 3, particularly preferably lower than 2, especially lower than 1.7. The aspect ratio of the crystallites is also preferably higher than 1, more preferably higher than 1.1, particularly higher than 1.3. The aspect ratio is defined by the ratio of the largest dimension to the smallest dimension of the crystallites (primary particles). It is preferably calculated using scanning electron microscopy, most efficiently by determining the largest dimension and the smallest dimension of at least 10 crystallites in an image and calculating the average thereof arithmetically.

According to the invention, the calcium carbonate particles preferably have a substantially rhombohedral crystal morphology. Advantageously at least 50%, preferably at least 75%, particularly preferably at least 90%, ideally at least 95%, especially at least 99% of the crystallites have a rhombohedral shape. In this context, the shape of the crystallites is preferably determined by scanning electron microscopy.

Calcium carbonate particles that are particularly well suited for the purposes of the present invention also have a specific surface area (BET) of at least 0.1 m²/g, preferably at least 1.0 m²/g, particularly preferably at least 3.0 m²/g, advantageously at least 4.0 m²/g, especially preferably at least 5.0 m²/g, and most preferably at least 10.0 m²/g. The specific surface area (BET) of the calcium carbonate particles is also preferably less than 30.0 m²/g, more preferably less than 25.0 m²/g, particularly preferably less than 20.0 m²/g, advantageously less than 15.0 m²/g. Within the terms of the present invention, the specific surface area (BET) of the calcium carbonate particles is most practically determined according to ISO 9277-1995.

Within the terms of the present invention, the calcium carbonate particles preferably have an average primary particle size of at least 10 nm, more preferably at least 30 nm, particularly preferably at least 50 nm, advantageously at least 70 nm, most particularly preferably at least 100 nm, ideally at least 150 nm, especially at least 200 nm. The average primary particle size is also preferably not larger than 20 μm, more preferably not larger than 10 μm, particularly preferably not larger than 1 μm, most preferably not larger than 0.75 μm, ideally not larger than 0.6 μm, especially not larger than 0.5 μm. The primary particle size is preferably determined by scanning tunneling microscopy (STM).

The particle size and particle size distribution of the calcium carbonate particles is preferably determined by sedimentation analysis, most practically with the aid of a Sedigraph 5100 (Micromeritics GmbH).

The average size of the calcium carbonate particles (corresponds to the d_{50%} value defined hereafter) is at least 0.030 μm, more preferably at least 0.050 μm, particularly preferably at least 0.070 μm, advantageously at least 0.100 μm, most particularly preferably at least 0.150 μm, ideally at least 0.250 μm, particularly at least 0.350 μm. The average size of the calcium carbonate particles is also not greater than 20 μm, more preferably not greater than 10 μm, particularly preferably not greater than 5 μm, advantageously not greater than 3 μm, most particularly preferably not greater than 2 μm, ideally not greater than 1.2 μm, especially not greater than 0.8 μm. The d_{50%} value is the particle size value at which the particle size of 50% by weight of the particles is smaller than or equal to the d_{50%} value.

The spread of the particle size distribution is preferably indicated by the granulometric factor of the particle size distribution. The granulometric factor is found with the following equation:

granulometric factor=(d_{84%}−d_{16%})/d_{50%},

wherein
d_{84%} designatesthe particle size value at which the particle size of 84% by weight of the particles is smaller than or equal to the d_{84%} value, and
d_{16%} designates the particle size value at which the particle size of 16% by weight of the particles is smaller than or equal to the d_{16%} value.

The granulometric factor of the particle size distribution of the calcium carbonate particles is preferably not more than 3.5, more preferably not more than 2.5, particularly not more than 1. The granulometric factor of the particle size distribution of the calcium carbonate particles is also preferably at least 0.05.

Within the terms of a particularly preferred embodiment of the present invention, the calcium carbonate particles are coated with at least one coating agent. Particularly preferred coating agents for these purposes include silanes, carboxylic acids, carboxylic acid salts, polyacrylic acids, polyacrylic acid salts and mixtures thereof. At the same time, said salts preferably do not include sodium salts.

The carboxylic acids may be aliphatic or aromatic, aliphatic carboxylic acids being particularly preferred.

The aliphatic carboxylic acids may be linear, branched or cyclic, substituted or unsubstituted, saturated or unsaturated aliphatic carboxylic acids. They preferably include at least 4, more preferably at least 8, particularly preferably at least 10, especially at least 14 carbon atoms. They also preferably include not more than 32, more preferably not more than 28, particularly preferably not more than 24, most particularly preferably not more than 22 carbon atoms.

Aliphatic carboxylic acids that are most particularly preferred for the purposes of the present invention include caproic acid, caprylic acid, capric acid, lauric acid, myristic acid, palmitic acid, stearic acid, isostearic acid, hydroxystearic acid, arachidic acid, behenic acid, lignorceric acid, hexacosanoic acid, montanic acid, triacontanoic acid, 9-tetradecenoi acid, palmitoleic acid, cis-6-octadecenoic acid, (Z)-octadec-9-eneoic acid, oleic acid, elaidic acid, linoleic acid, trans-9,trans-12-octadecadienoic acid, linolenic acid, trans-9,trans-12-octadecadienoic acid, α-elaeostearic acid, β-elaeostearic acid, gadoleic acid, arachidonic acid, erucic acid, trans-13-docosenoic acid and all-cis-7,10,13,16,19-docosapentaenoic acid. Mixtures and/or salts of these carboxylic acids are also particularly advantageous. Mixtures containing essentially palmitic acid, stearic acid and oleic acid are most particularly preferred. Mixtures with the designation “stearin” that also contain 30% by weight to 40% by weight stearic acid, 40% by weight to 50% by weight palmitic acid and 13% by weight to 20% by weight oleic acid are especially suitable for the purposes of the present invention.

Other preferred aliphatic carboxylic acids include resin acids, particularly levopimaric acid, neoabietic acid, palustric acid, abietic acid and dehydroabietic acid. Mixtures and/or salts of such carboxylic acids are also particularly advantageous.

Preferred salts of carboxylic acids, particularly aliphatic carboxylic acids, include potassium, ammonium and calcium salts, calcium salts of carboxylic acids being particularly preferred.

For the purposes of the present invention, preferred polyacrylic acids have a weight average molecular weight of at least 500 g/mol, preferably at least 700 g/mol, particularly at least 1000 g/mol. In addition, the molecular weight thereof is not more than 15000 g/mol, preferably not more than 4000 g/mol, particularly not more than 2000 g/mol. In addition, mixtures and/or salts of such polyacrylic acids are particularly advantageous.

Preferred salts of polyacrylic acids include potassium, ammonium and calcium salts, calcium salts of polyacrylic acids being particularly preferred.

In principle, the coating agent portion may be chosen freely. It constitutes preferably at least 0.0001% by weight, more preferably at least 0.001% by weight, particularly preferably at least 0.01% by weight, especially preferably at least 0.05% by weight relative to the total weight of the coated calcium carbonate particles. In addition, it preferably constitutes not more than 60% by weight, more preferably not more than 25% by weight, particularly preferably not more than 10% by weight, especially preferably not more than 6% by weight relative to the total weight of the coated calcium carbonate particles.

The optionally coated calcium carbonate particles to be used according to the invention may be produced in known manner. Such production is particularly described in detail in patent application WO 2007/068593, the disclosure of which is included in the present application by reference.

The relative proportions of the components of the first hollow fiber are not subject to any special restrictions and may be chosen freely. For the purposes of the present invention, however, it is particularly expedient of the weight ratio of polymer calcium carbonate is in the range from 95:5 to 50:50, preferably in the range from 90:10 to 60:40, particularly in the range from 80:20 to 70:30.

The first hollow fiber also includes preferably at least 25.0% by weight, more preferably at least 50.0% by weight, particularly preferably at least 60.0% by weight polymer and preferably at least 1.0% by weight, more preferably at least 5.0% by weight, particularly preferably at least 10.0% by weight, particularly preferably at least 20.0% by weight calcium carbonate, relative to the total weight of the hollow fiber in each case, wherein the fractions of polymer and calcium carbonate combined constitute preferably at least 75.0% by weight, more preferably at least 90.0% by weight, particularly preferably at least 95.0% by weight thereof. In addition, the first hollow fiber is preferably constituted by not more than 50.0% by weight, more preferably not more than 40.0% by weight, particularly preferably not more than 35.0% by weight calcium carbonate particles, relative to the total weight of the hollow fiber in each case.

The first hollow fiber may be produced in known manner. It is practical to begin with a compound that contains the polymer and the calcium carbonate. It is particularly advantageous to add an organic nucleating agent to the mixture, since this enables the calcium carbonate crystallites in the polymer to be reduced significantly and crack propagation becomes much more homogeneous. Nucleating agents that are particularly well suited for the purposes of the present invention include polyvalent alcohols including preferably at least 2, more preferably at least 3, particularly preferably at least 4, ideally at least 5, especially at least 6 hydroxyl groups, each preferably present in the form of CHOH groups. Especially suitable nucleating agents include ethylene glycol, glycerin, threitol, erythritol, arabite, ribite, adonite, xylite, sorbite, mannite, dulcite, wherein compounds with more than 4, more preferably more than 6 carbon atoms are particularly preferred.

The proportion of nucleating agent in the compound is preferably not more than 5% by weight, more preferably in the range from 0.1% by weight to not more than 3% by weight, particularly preferably in the range from 0.2% by weight to not more than 1.5% by weight, especially in the range from 0.3% by weight to 0.75% by weight, relative to the total weight of the compound in each case, wherein the combined weights of polymer, calcium carbonate and nucleating agent constitute preferably at least 85.0% by weight, more preferably at least 90.0% by weight, particularly preferably at least 95.0% by weight, especially at least 99.0% by weight of the compound.

The compound containing the polymer and the calcium carbonate particles is preferably melt spun using a nozzle for forming hollow fibers. In this way, an unstretched hollow fiber is obtained that is preferably orientated and highly crystallized. Further details regarding nozzles for forming hollow fibers can be found in the standard technical literature, particularly Franz Fourné, Synthetische Fasern: Herstellung, Maschinen und Apparate, Eigenschaften; Handbuch für Anlagenplanung, Maschinenkonstruktion und Betrieb Munich, Vienna; Hanser Verlag, 1995, and the sources cited therein.

Although a nozzle with a double tube construction is preferred, because it is able to yield a substantially uniform section, a horseshoe-shaped nozzle or a nozzle with some other shape may also be used. If a nozzle with double tube construction is used, the air that is passed into the hollow fiber to maintain the hollow shape thereof may be fed in spontaneously or forced.

In order to keep the first hollow fiber of the present invention stable, it is desirable for the spinning temperature to be 20° C. to 150° C. higher than the melting point of the polymer.

The polymer that is extruded at a suitable spinning temperature is preferably drawn off with a spinning draft of 5 to 5000.

The resulting first hollow fiber is preferably highly orientated in the lengthwise direction and preferably has an internal diameter of 100 μm and 2000 μm and a wall thickness of 15 μm to 800 μm.

It is particularly well suited for manufacturing the porous hollow fiber according to the invention. This in turn comprises first pores having
an average length in the range from 0.045 μm to 120 μm, preferably in the range from 0.105 μm to 60 μm, more preferably in the range from 0.150 μm to 30 μm, particularly preferably in the range from 0.225 μm to 18 μm, advantageously in the range from 0.375 μm to 12 μm, most preferably in the range from 0.525 μm to 7.2 μm, especially in the range from 0.600 μm to 6.4 μm, and
an average width in the range from 0.030 μm to 20 μm, preferably in the range from 0.050 μm to 10 μm, more preferably in the range from 0.070 μm to 5 μm, particularly preferably in the range from 0.100 μm to 3 μm, advantageously in the range from 0.150 μm to 2 μm, most preferably in the range from 0.250 μm to 1.2 μm, especially in the range from 0.350 μm to 0.8 μm, measured in the direction of the fiber in each case,
   wherein the ratio of the average length of the first pores to the average width of the first pores is at least 1.5:1, preferably at least 2:1, more preferably at least 3:1, particularly preferably at least 5:1, advantageously at least 7.5:1, especially at least 10:1.

The porous hollow fiber also comprises second pores having
an average length in the range from 0.1 nm to 99 nm, preferably in the range from 0.2 nm to 90 nm, more preferably in the range from 0.3 nm to 80 nm, particularly preferably in the range from 0.4 nm to 70 nm, advantageously in the range from 0.5 nm to 60 nm, especially in the range from 0.75 nm to 50 nm, and
an average width in the range from 1 nm to 20000 nm, preferably in the range from 5 nm to 15000 nm, more preferably in the range from 10 nm to 10000 nm, particularly preferably in the range from 20 nm to 5000 nm, in the range from 30 nm to 2000 nm, especially in the range from 50 nm to 1000 nm, measured in the direction of the fiber in each case,
   wherein the ratio of the average length of the second pores to the average width of the second pores is not more than 1:1.5, preferably not more than 1:2, more preferably not more than 1:3, particularly preferably not more than 1:5, advantageously not more than 1:7.5, especially not more than 1:10.

The corresponding values for the average length and width of the respective pores are preferably determined using electron microscopy, wherein an arithmetical mean is preferably calculated from at least 5, preferably at least 10, particularly at least 15 pores in an image.

In order to produce the porous hollow fiber of the invention, the first hollow fiber is preferably stretched to an elongation of more than 50%, more preferably more than 100%, particularly preferably more than 200%, most preferably in the range from 300% to 600% relative to the initial length of the hollow fiber in each case, and measured at 25° C.

First, this first hollow fiber undergoes heat treatment, suitably at a temperature in the range from 100° C. to 165° C., preferably in the range from 110° C. to 155° C. before stretching. The heat treatment (or tempering) time is preferably in the order of 30 min or more.

The actual stretching of the hollow fiber is preferably carried out at a temperature in the range from 100° C. to 165° C., more preferably in the range from 110° C. to 155° C.

The deformation rate during stretching is preferably set to not more than 10% per second. In addition, a stretching speed in the range from 10 cm/min to 110 cm/min is favorable for the process.

The expression “deformation rate” as used herein means a value that is obtained by dividing the stretched quantity (in %) in a stretching area by the time (in seconds) that is needed for the hollow fiber to pass the stretching area.

Within the terms of a particularly preferred variant of the present invention, after stretching at least some of the calcium carbonate particles are removed from the porous hollow fiber. For this purpose, preferably a suitable solvent is used, which is more preferably an aqueous compound, particularly preferably an acidic aqueous compound, which preferably further contains at least one alcohol, particularly methanol, ethanol or propanol. The residual calcium carbonate content of the porous hollow fiber after the removal of at least some of the calcium carbonate particles is preferably less than 30% by weight, more preferably less than 20% by weight, particularly preferably less than 10% by weight, suitably less than 5% by weight, especially preferably less than 1% by weight, most preferably less than 0.1% by weight, relative to the total weight of the porous hollow fiber in each case.

The resulting porous hollow fibers have an essentially stabilized form and do not necessarily require a thermal fixing step for fixing the porous structure. If desired, however, they may be thermally fixed at a constant length under tensile load or under no-load conditions in the same temperature range is as used for stretching.

Preferred application areas of the porous hollow fiber according to the invention include their use in filling materials for bedspreads, pillows, sleeping bags, protective clothing for cold weather, in selectively permeable membranes, particularly capillary membrane filters, in ultrafiltration, microfiltration and reverse osmosis, for desalinating, concentrating, fractionating proteins, enzymes and similar, for breaking down gas mixtures, as an oxygenator in artificial lungs, for plasma separation in dialysis, in catalytic conversion and recovery of catalysts. It is also particularly well suited for immobilizing enzymes and/or cells, and for haemodialysis. Its use for storing hydrogen, for fuel cells for example, is also particularly advantageous. The use of the porous hollow fiber according to the invention for microfiltration is particularly preferred in this context.

In the following, the invention will be illustrated in greater detail with reference to an example thereof, wherein the illustration is not intended to represent a limitation of any kind to the inventive thought.

### EXAMPLE 1

Starting with a rhombohedral, precipitated calcium carbonate (calcite particles; aspect ratio: 1:5; edge length approximately 350 nm; particle size distribution (sedimentation analysis using the Sedigraph 5100): d_{84%}=800 nm; d_{50%}=570 nm; d_{16%}=400 nm; BET: 7.0 m²/g) a blend was produced according to the following formulation:

Formulation
30 g isotactic polypropylene
10 g precipitated calcium carbonate
0.14 g organic nucleating agent (sorbitol derivative)

The samples were mixed in ten batches at 210° C. in a microcompounder at a speed of 80 revolutions per minute for a period of four minutes after melting.

The prepared mixture was spun in a piston spinning device with hollow nozzle at 240° C. and with a drawing speed of 100 m/min.

The spun hollow fiber was stretched at a temperature of 130° C. at a speed of 50 cm/min (original fiber length: 5 cm) to an elongation of 400%.

The hollow fiber produced in this way exhibits micropores elongated in the direction of stretching over the entire volume thereof, which micropores have an average pore length of 10 μm and an average pore width of 1 μm. The micropores have a consistent structure. Moreover, the hollow fibers produced in this way have nanopores with an average pore width of 100 nm and an average pore length of 10 nm, viewed in the stretching direction.

The calcium carbonate particles were removed from the hollow fibers with the aid of a mixture (50:50) of methanol and hydrochloric acid.

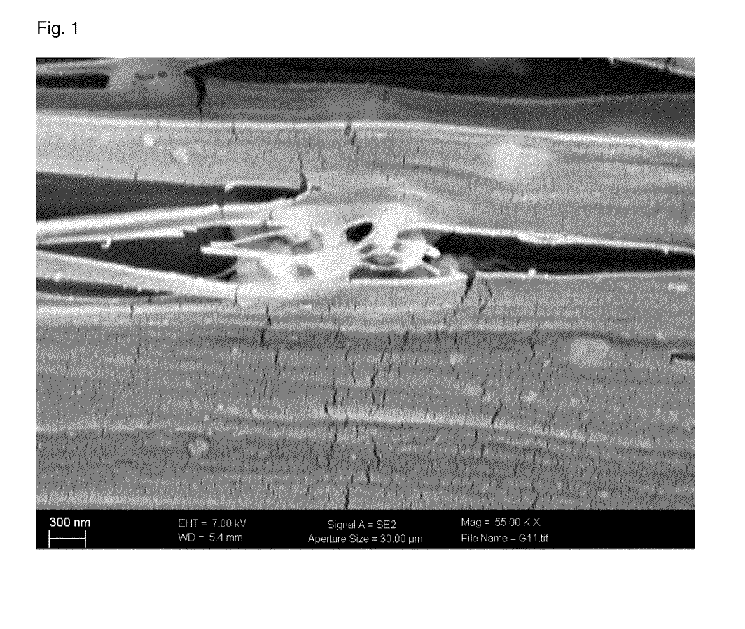

FIG. 1 shows a scanning tunneling microscope image of a stretched hollow fiber that contains first pores in the thread direction, second pores transversely to the thread direction, and calcium carbonate particles.

1. A porous hollow fiber comprising first pores having an average length in a range from 0.045 μm to 120 μm and an average width in a range from 0.030 μm to 20 μm, measured in a direction of the fiber in each case, wherein a ratio of the average length of the first pores to the average width of the first pores is at least 1.5:1,
wherein the hollow fiber further comprises second pores having an average length in a range from 0.1 nm to 99 nm and an average width in a range from 1 nm to 20000 nm, measured in the direction of the fiber in each case, wherein a ratio of the average length of the second pores to the average width of the second pores is not more than 1:1.5.

2. The hollow fiber according to claim 1, comprising at least one polymer and calcium carbonate particles, wherein the calcium carbonate particles have an average d_{50%} particle size in a range from 30 nm to 20 μm and crystallites of the calcium carbonate particles have an aspect ratio less than 5.

3. The hollow fiber according to claim 1, having a hollow interior space with an internal diameter in a range from 100 μm to 2000 μm, and a mantle with a wall thickness in a range from 15 μm to 800 μm.

4. The hollow fiber according to claim 2, wherein the calcium carbonate particles have a d_{50%} average particle size in a range from 150 nm to 2 μm.

5. The hollow fiber according to claim 2, wherein the calcium carbonate particles have an aspect ratio in a range from 1.1 to 4.0.

6. The hollow fiber according to claim 2, comprising a rhombohedral precipitated calcium carbonate.

7. The hollow fiber according to claim 2, wherein a granulometric factor of the calcium carbonate particles is not greater than 3.5.

8. The hollow fiber according to claim 2, wherein the calcium carbonate particles are coated with at least one coating agent.

9. The hollow fiber according to claim 2, wherein a weight ratio of polymer to calcium carbonate is in a range from 95:5 to 50:50.

10. A process for producing a hollow fiber according to claim 2, comprising melt spinning a compound comprising the polymer and the calcium carbonate particles using a nozzle designed for forming hollow fibers.

11. A process for producing a porous hollow fiber according to claim 1, comprising stretching a hollow fiber to an elongation greater than 50% relative to an initial length of the hollow fiber, the hollow fiber comprising at least one polymer and calcium carbonate particles, wherein the calcium carbonate articles have an average d_{50%} particle size in a ranee from 30 nm to 20 μm and crystallites of the calcium carbonate particles have an aspect ratio less than 5.

12. The process according to claim 11, comprising stretching the hollow fiber at a temperature in the range from 100° C. to 165° C.

13. The process according to claim 11, wherein a deformation rate during stretching does not exceed 10% per second.

14. The process according to claim 11, comprising removing at least some of the calcium carbonate particles from the hollow fiber after stretching.

15. Use of a porous hollow fiber according to claim 1 in filling materials, in selectively permeable membranes, for immobilizing enzymes and/or cells, for haemodialysis, or for storing hydrogen.
